(19) United States
(12) Patent Application Publication
(10) Pub. No.: US 2024/0416733 A1
(43) Pub. Date: Dec. 19, 2024

(54) SELF-ADAPTING REMOVABLE COVER SYSTEM AND TRAILER, SEMI-TRAILER, DUMP BODY, WAGON OR BUILDING PROVIDED WITH SUCH A SYSTEM

(71) Applicant: INNOVACTION TECHNOLOGIES, Eperciex St. Paul (FR)

(72) Inventor: Srecko Sajnovic, Eperciex St. Paul (FR)

(73) Assignee: INNOVACTION TECHNOLOGIES, Eperciex St. Paul (FR)

(21) Appl. No.: 18/701,494

(22) PCT Filed: Oct. 17, 2022
(86) PCT No.: PCT/FR2022/051949

§ 371 Date: Apr. 15, 2024

(30) Foreign Application Priority Data
Oct. 25, 2021 (FR) FR2111321

(51) Int. Cl. B60J 7/06; E04D 11/00

(52) U.S. Cl. CPC B60J 7/062; E04D 11/00

(57) ABSTRACT

The invention relates to a removable cover system comprising at least one arch (6) provided at each of its ends with a slider (5), each slider (5) travelling in a traveller track (4), a flexible cover (3) being fixed to at least one arch (5), comprising an at least partially hollow arch (6), comprising at each of its ends: • a plate (7) connected by one end to a slider (5) and connected by its other end to a plate (10), • a spacer (11) in contact with the plate (10) and comprising a rectilinear slot close to one end, a curved end of the plate (10) being inserted into the rectilinear slot in the spacer (11), • the plate (10) and the spacer (11) being disposed inside the hollow part of the arch (6) and being secured by a screw and bolt fastening assembly, and • the plate (10) and the spacer (11) being provided with a longitudinal slot configured to cooperate with the screw and bolt fastening assembly such that the arch (6) slides with respect to the plate (10) and the spacer (11).

### TECHNICAL FIELD

The invention relates to the technical field of cover systems for dump bodies and trailers, more specifically the flexible sectional cover systems for dump bodies and trailers.

### PRIOR ART

A removable cover system allows covering or uncovering the opening of a dump body or of a trailer by driving arches linked to a flexible removable cover. In general, the arches are supported by a track and fastened to a drive cable which allows moving them in either direction, driving the removable cover during movement thereof.

In the prior art, the document FR1256895 disclosing a removable cover for a truck dump body is known, which describes a winding/unwinding system allowing addressing the problems of tensioning of the cables and of offset of the steering arch of the cover.

Such a removable cover system allows effectively taking account of the tensioning losses in the cables due to openings and closures as well as the impacts on the arches.

Nevertheless, such a removable cover system is based on the assumption that a trailer or a dump body is a rigid parallelepiped. In reality, a trailer or a dump body is subjected to deformation effects during loading and unloading which could lead to a displacement of the upper end of the lateral walls by more than 15 cm for a 15 m long trailer.

Such a deformation of the walls generates high mechanical stresses in the system of the removable cover, in particular at the arches and the flexible covers. If the stress exceeds the elastic limit of the arches, a plastic deformation might appear as well as a jamming of the sliders in the track.

There is a need for a removable cover system that could adapt to the deformation of the lateral walls of a trailer, a semi-trailer or a dump body.

The buildings exposed to day/night temperature variations are exposed to considerable expansion effects. Depending on the used materials, the deformation is not uniform and could lead to stresses in the cover systems.

Thus, there is a need for a removable cover system that could adapt to the deformation of the walls of a building.

### DISCLOSURE OF THE INVENTION

An object of the invention is a removable cover system comprising at least one arch provided at each of its ends with a slider, each slider traveling in a traveler track, a flexible cover being fastened to the at least one arch. The system comprises an at least partially hollow arch, comprising at each of its ends:
a first plate connected at one end to a slider and connected at its other end to a second plate,
a spacer in contact with the second plate and comprising a rectilinear slot close to one end, a curved end of the second plate being inserted into the rectilinear slot of the spacer,
the second plate and the spacer being arranged inside the hollow part of the arch and secured by a screw and bolt fastening assembly, and
the second plate and the spacer being provided with a longitudinal slot configured to cooperate with the screw and bolt fastening assembly, so that the arch slides with respect to the second plate and the spacer.

The first plate may be provided close to its other end with a rectilinear slot, the second plate comprising a curved end inserted into the rectilinear slot of the premiere plate, the spacer being configured to secure the position of the first curved end of the second plate in the rectilinear slot of the first plate.

The removable cover system may comprise a spring tensioning device provided with a flange and two springs, each of the two springs comprising at one of their ends a hooking loop and a fastener to the first plate at their other ends, each end of the flange comprising a hook cooperating with a hooking loop of one of the two springs, the flange being configured to be inserted into slots formed in the flexible cover and to engage the hooks at its ends in the hooking loops at the end of the springs, so that the flexible cover is secured to the arch while having freedom of movement according to the tensioning direction of the springs, under the action of the springs.

The ends of the flange may have an S-shaped profile so that the hooks are offset with respect to the body of the flange.

The removable cover system may comprise a protection arranged between the flexible cover and the metal structure formed by the arch and the first plate, configured to protect the flexible cover from frictions.

Another object of the invention is a trailer provided with a removable cover system as described hereinabove, wherein the traveler tracks are arranged on opposite lateral walls.

Another object of the invention is a semi-trailer provided with a removable cover system as described hereinabove, wherein the traveler tracks are arranged on opposite lateral walls.

Another object of the invention is a dump body provided with a removable cover system as described hereinabove, wherein the traveler tracks are arranged on opposite lateral walls.

Another object of the invention is a wagon provided with a removable cover system as described hereinabove, wherein the traveler tracks are arranged on opposite lateral walls.

Another object of the invention is a building provided with a removable cover system as described hereinabove, wherein the traveler tracks are arranged on opposite lateral walls.

### BRIEF DESCRIPTION OF THE DRAWINGS

Other aims, features and advantages of the invention will appear upon reading the following description, given only as a non-limiting example and made with reference to the appended drawings wherein:

FIG. 1 illustrates the main elements of a top-down view on the removable cover system installed on a trailer,

FIG. 2 illustrates the main elements of a partial view of the removable cover system restricted to an arch,

FIG. 3 illustrates the main elements of a sectional view of the removable cover system at an arch, and

FIG. 4 illustrates the main elements of a top-down view of the removable cover system at one arch.

### DETAILED DESCRIPTION

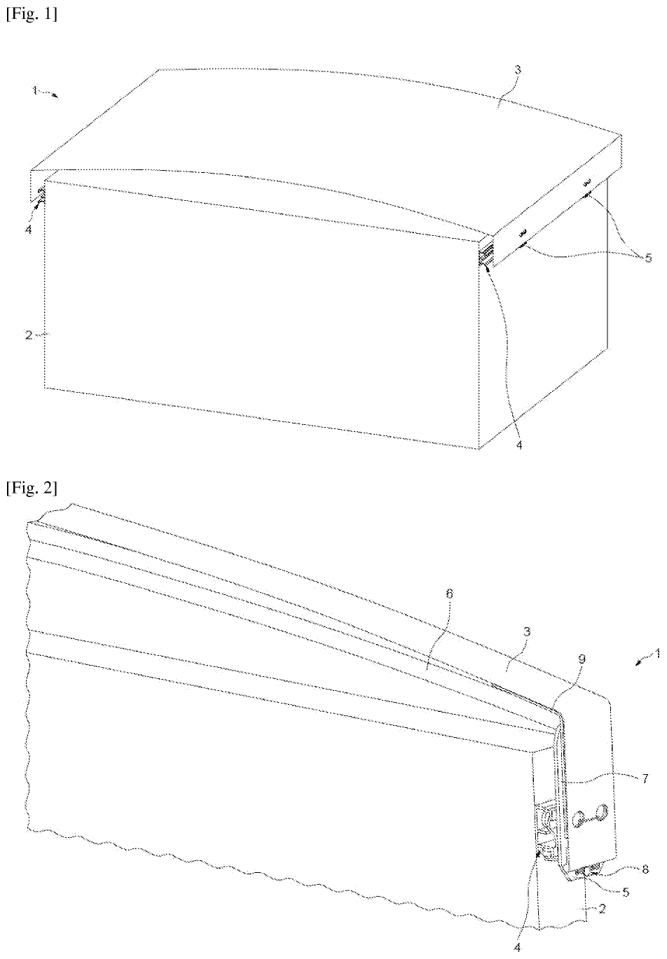

In FIG. 1, the removable cover system 1 according to the invention is arranged on a trailer 2. It should be noted, in the rest of the description, that the removable cover system 1 could also be installed on a semi-trailer, a dump body, on a wagon, or on a building.

The removable cover system 1 comprises a flexible cover 3 arranged on arches each fastened at each of their ends to a slider 5. Afterwards, the sliders 5 slide in two traveler tracks 4 each arranged on one of the lateral walls on each side of the trailer 2. In FIG. 1, the arches are hidden by the flexible cover 3 and are not therefore illustrated in FIG. 1. The sliders 5 and the traveler tracks 4 illustrated in FIG. 1 are merely illustrative. Other sliders 5 and tracks may be used while remaining within the scope of the invention.

FIG. 2 illustrates a partial view of the removable cover system 1 restricted at one end of an arch 6.

Thus, the arch 6 is fastened by one of its ends to a slider 5 by means of a first plate 7. The slider 5 is arranged in a traveler track 4 so as to be able to move longitudinally without departing from the traveler track 4. The traveler track 4 is fastened on a lateral wall of the trailer 2.

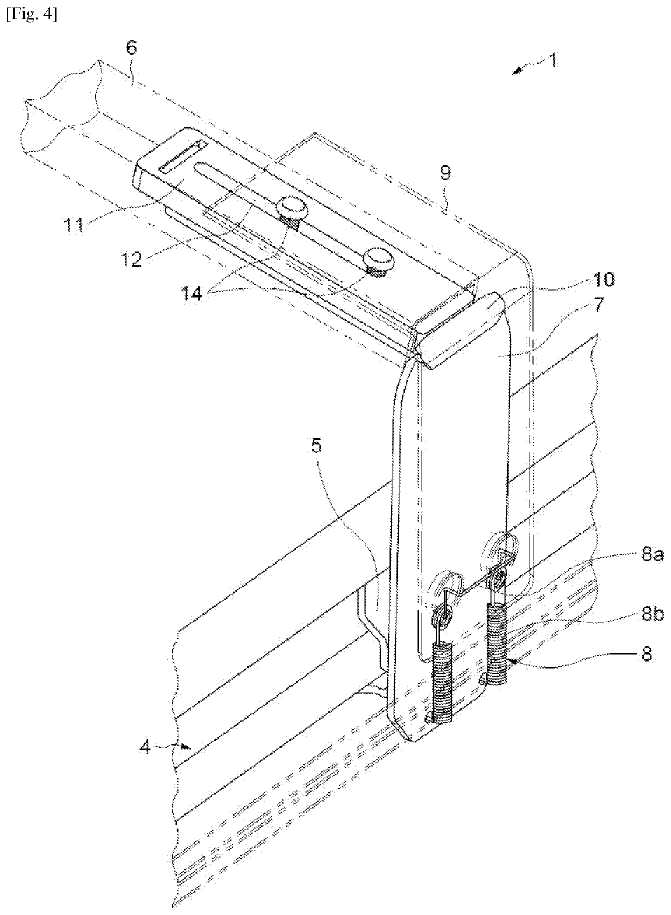

The flexible cover 3 is arranged on the arch 6 and the first plate 7 and is held in place by a spring tensioning device 8, which will be described later on with reference to FIG. 4. Thanks to the use of the spring tensioning device 8, the flexible cover 3 has a freedom of vertical position on the first plate 7 compared to conventional fasteners by lathering, screwing or riveting.

A protection 9 may be arranged between the flexible cover 3 and the metal structure formed by the arch 6 and the first plate 7 to protect the flexible cover 3 from frictions.

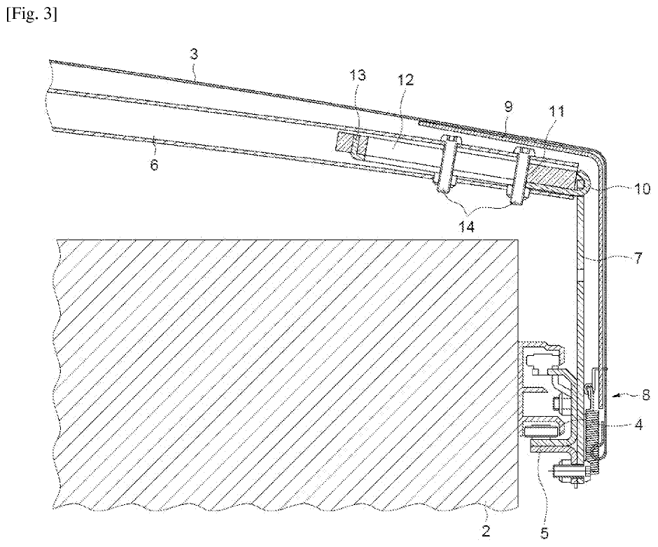

FIG. 3 illustrates a sectional view of the removable cover system 1 at one arch 6.

The flexible cover 3 arranged on the arch 6 and the first plate 7 is found, the flexible cover 3 being fastened by the spring tensioning device 8 at the base of the first plate 7. The first plate 7 is securely fastened to the slider 5 arranged in the traveler track 4.

The structure of the arch 6 is illustrated in this same FIG. 3. The arch 6 has an arcuate parallelepiped shape with a hollow section. The arch 6 is connected to the first plate 7 by means of a second plate 10 at the curved ends, associated with a spacer 11. A first curved end of the second plate 10 is arranged in a corresponding slot of the first plate 7. The spacer 11 is arranged in contact with the second plate 10 so as to be in contact with the first curved end. The second curved end of the second plate 10 is then inserted into a slot 13 of the spacer 11.

The arch 6 is then arranged so as to contain the second plate 10 and the spacer 11. Two screw and bolt assemblies 14 are securely fastened to the arch 6 and are arranged so as to pass through an oblong slot 12 formed in the second plate 10 and the spacer 11.

Thus fastened, the arch 6 can slide on the assembly formed by the second plate 10 and the spacer 11 over a length defined by the spacing between the screw and bolt assemblies 14 and the length of the oblong slot 12.

Fastening of the second plate 10 on the first plate 7 allows keeping a rotational degree of freedom and the spacer 11 allows avoiding the separation of the second plate 10 and of the first plate 7 because of vibration or an impact.

Fastening of the second plate 10 on the first plate 7 and the slide of the arch 6 on the assembly formed by the second plate 10 and the spacer 11 allow compensating for a variation in distance between the upper ends of the lateral walls of the trailer 2. Such a distance variation is commonly observed during trembling of the trailer 2 in movement or when loading the trailer 2. It should be recalled that it is common to observe that such a variation is greater than 15 cm.

FIG. 4 illustrates a top-down view on the end of the arch 6. Compared to FIG. 3, FIG. 4 further illustrates the spring tensioning device 8.

The spring tensioning device 8 comprises a flange 8a cooperating with two parallel springs 8b secured to the first plate 7. More specifically, the two springs 8b comprise a first end provided with a hooking loop and a second end fastened to the first plate 7. Each end of the flange 8a comprises a hook cooperating with a hooking loop of one of the two springs 8b. Thus, it is possible to insert the flange 8a in slots formed in the flexible cover 3 and to engage the hooks in the hooking loops at the end of the springs 8b. The flexible cover 3 is then secured to the arch 6 while having a freedom of movement according to the tensioning direction of the springs 8b, while remaining tensioned thanks to the action of the springs 8b.

The ends of the flange 8a may have an S-shaped profile so that the hooks are offset with respect to the body of the flange. The insertion of the hooks is then facilitated by the possibility of imparting a traction movement on the body of the flange while holding the hooks opposite the hooking loops.

The removable cover system 1 allows adapting to a variation in the distance between the traveler tracks 4 so as to avoid jams. The adaptation is done at the slide of the arch 6, allowing modifying its length, at the rotation between the second plate 10 and the first plate 7, allowing modifying the angle therebetween, and at the spring tensioning device 8, allowing modifying the position of the end of the removable cover 3 with respect to the arch 6.

It should be understood that the above-described modifications of positions or angles are done passively, during the operation of the removable cover system, without any intervention by an operator.

1. A removable cover system comprising at least one arch (6) provided at each of its ends with a slider (5), each slider (5) traveling in a traveler track (4), a flexible cover (3) being fastened to the at least one arch (6), characterized in that it comprises an at least partially hollow arch (6), comprising at each of its ends:
a first plate (7) connected at one end to a slider (5) and connected at its other end to a second plate (10),
a spacer (11) in contact with the second plate (10) and comprising a rectilinear slot close to one end, a curved end of the second plate (10) being inserted into the rectilinear slot of the spacer (11),
the second plate (10) and the spacer (11) being arranged inside the hollow part of the arch (6) and secured by a screw and bolt fastening assembly, and
the second plate (10) and the spacer (11) being provided with a longitudinal slot configured to cooperate with the screw and bolt fastening assembly, so that the arch (6) slides with respect to the second plate (10) and the spacer (11).

2. The removable cover system according to claim 1, wherein the first plate (7) is provided close to its other end with a rectilinear slot, the second plate (10) comprising a curved end inserted into the rectilinear slot of the first plate (7), the spacer (11) being configured to secure the position of the first curved end of the second plate (10) in the rectilinear slot of the first plate (7).

3. The removable cover system according to claim 1, comprising a spring tensioning device (8) provided with a flange (8a) and two springs (8b), each of the two springs (8b) comprising at one of their ends a hooking loop and a fastener to the first plate (7) at their other ends, each end of the flange (8a) comprising a hook cooperating with a hooking loop of one of the two springs (8b), the flange (8a) being configured to be inserted into slots formed in the flexible cover (3) and to engage the hooks at its ends in the hooking loops at the end of the springs (8b), so that the flexible cover (3) is secured to the arch (6) while having freedom of movement according to the tensioning direction of the springs (8b), under the action of the springs (8b).

4. The removable cover system according to claim 3, wherein the ends of the flange (8a) have an S-shaped profile so that the hooks are offset with respect to the body of the flange.

5. The removable cover system according to claim 1, comprising a protection (9) arranged between the flexible cover (3) and the metal structure formed by the arch (6) and the first plate (7), configured to protect the flexible cover (3) from frictions.

6. A trailer provided with a removable cover system according to claim 1, wherein the traveler tracks (4) are arranged on opposite lateral walls.

7. A semi-trailer provided with a removable cover system according to claim 1, wherein the traveler tracks (4) are arranged on opposite lateral walls.

8. A dump body provided with a removable cover system according to claim 1, wherein the traveler tracks (4) are arranged on opposite lateral walls.

9. A wagon provided with a removable cover system according to claim 1, wherein the traveler tracks (4) are arranged on opposite lateral walls.

10. A building provided with a removable cover system according to claim 1, wherein the traveler tracks (4) are arranged on opposite lateral walls.
